(19) United States
(12) Patent Application Publication
(10) Pub. No.: US 2006/0032456 A1
(43) Pub. Date: Feb. 16, 2006

(54) Bag for pet animal

(76) Inventor: Yong-Tae Kwon, Daejeon (KR)

Correspondence Address: IPLA P.A., 3580 WILSHIRE BLVD., 17TH FLOOR, LOS ANGELES, CA, 90010, US

(21) Appl. No.: 10/533,258

(22) PCT Filed: Oct. 1, 2003
(86) PCT No.: PCT/KR03/02021

§ 371 Date: Apr. 29, 2005

(30) Foreign Application Priority Data
Nov. 5, 2002 (KR) 20-2002-0033063

(51) Int. Cl. A01K 1/03

(52) U.S. Cl. 119/497

(57) ABSTRACT

This invention is about a bag for a pet. It has fluid acceptation space which is suitable for physical character of a pet. Also it makes a pet safe and a man easy to walk as wearing more closer to his body. It consist of a main body which of space made bottom gradient to body direction from the front of be in pet's head, a form frame which set a pair with a flexible cushion on open surface and get smaller in diameter, and a changeable length shoulder strap which link both of a main body.

### TECHNICAL FIELD

It is about the moving bag for a pet to move a pet easily.

First of all, it has space suitable for a physical characteristic of a pet, so it can keep and move with maintaining comfortable position.

Second, it makes a pet feel easy as closing the open-part, when he sleeps or it rains or it is a cold wave.

Third, a man can walk easy and free two hands because of wearing a bag closest to body.

Lastly, a pet feels coziness in his master's bosom and both of a pet and man have convenience at walk.

### BACKGROUND

Generally, the pet's bag divide a knapsack type wearing forward and a sports type wearing aside.

The former is the way to tie a belt crossed to the neck, so it is uncomfortable. And it consists of X-type belt crossing on the back and fixed belt, so it has a problem to set-up from length controlling.

The latter has a problem it can not keep a pet comfortable because it dose not consider physical condition of a pet.

The pet feel most comfortable when he down with a stoop like a FIG. 3, then he keeps his neck straightly and his body at the back is bigger than forward.

For protect a pet's body from the outside and keep him most comfortable pose, it has to possess space to cover all body except face.

But the existing pet bag didn't satisfy these conditions,

And the existing pet-bag makes a pet comfortable when he sleeps or it rains or it is a cold wave, but it has a problem with open-close control of a bag.

Also it feels bad because it doesn't adhere closely to user's body when he put on a bag crossly and feel pets uneasy because of shaking on walk.

### DISCLOSURE OF THE INVENTION

It is suggested to solve the above problems.

The main body of the bag has, considering physical feature of pets, a space to keep most comfortable pose for pets.

The open-close control of the bag is easy to stick a pet's head outside if necessary. The form-holder of the bag adhere closely to user's body when he put on a bag. These are our aim for invention.

This invention for attain above goal consist of a main body which of space made bottom gradient to body direction from the front of be in pet's head, a form frame which set a pair with a flexible cushion on open surface and get smaller in diameter, and a changeable length shoulder strap which link both of a main body.

### BRIEF DESCRIPTION OF THE DRAWINGS

FIG. 1 is a side view of opened admitted-space.

FIG. 2 is a side view of closed admitted-space.

FIG. 3 is a front view of a pet in the bag.

FIG. 4 is a enlarged cross-sectional view of sliced piece of the for m-holder.

FIG. 5 is a plane cross-sectional view of opened admitted-space.

FIG. 6 is a plane cross-sectional view of closed admitted-space.

FIG. 7 is a side cross-sectional view of opened form-holder.

FIG. 8 is a plane cross-sectional view of the extended part between a form-holder and a shoulder strap.

### EXAMPLE

It is explanation about organization of the correct operation example for the attainment of this invention's aim.

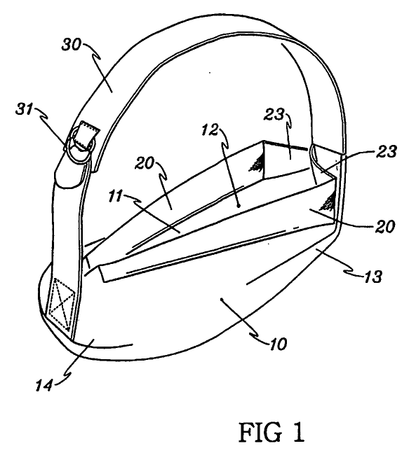

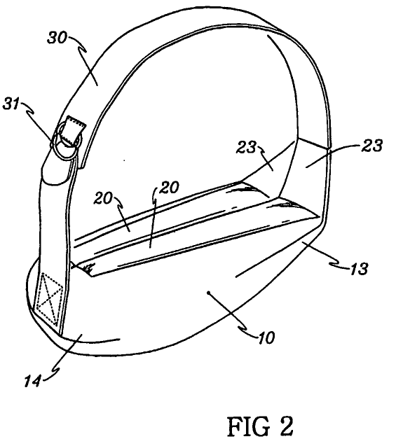

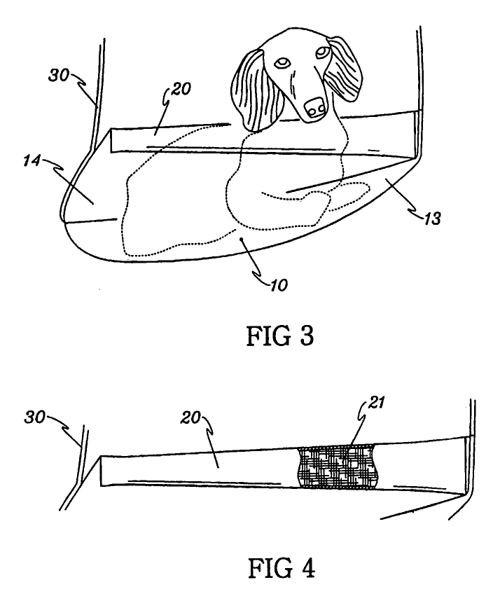

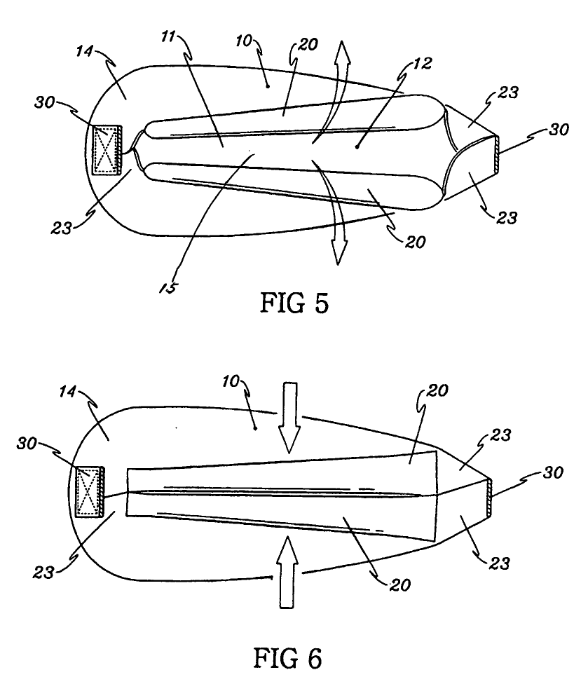

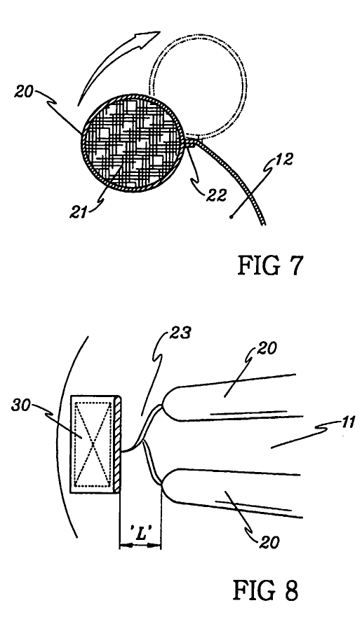

Roughly speaking about organization of this invention, like FIG. 1 or FIG. 3, it consists of main body (10) that it has admitted-space (12) to keep pets most comfortable pose, a couple of form-holder (20) that it is set on the upside the open-part (11) of the main body (10) so it keep a frame of main body (10) and open or close the open-part (11) optionally and the shoulder strap (30) that it join both of main body (10) so user wear it his shoulder.

It is explanation in more detail about invention organized above.

First of all, the main body (10) of the bag having admitted-space (12) have the open-part (11) to go in and out at the upside, the head-part (13) to locate head of pets in the admitted-space (12) under the open-part (11) and the body-part (14) to locate body of pets at the opposite head-part (13).

The reason why divide the admitted-space (12) into the head-part (13) and the body-part (14) is to consider physical factor of pets, and let pets stoop down, that is the pose to keep pets most comfort.

The admitted-space (12) made bottom gradient to the body-part (14) direction from the front of be in the head-part (13), so it keep a form of a deep pocket that the body-part (14) is deeper than the head-part (13). Then pets can be admitted in admitted-space (12) comfortably with stooping down and see outside through the open-part (11).

The form-holder (20) which set a pair with a flexible cushion (21) on surface of the open-part (11), so pets don't feel a pain when it is touched a neck of pets and the main body (10) made of a fibrous tissue keep the basic frame.

It get smaller in diameter to the body-part (14) from the head-part (13) of the admitted-space (12), because it makes a pet safe, and a man easy to walk as wearing more closer to his body, and it rest a pet's chin on it to fill a habit of a pet which rest a pet's chin on master's arm and to feel easy.

If the diameter of the form-holder (20) is the same, user can not adhere closely to his body because of a falling off in quality of curve. But the form-holder (20) of this invention is easy to adhere closely to user's body because of good quality of curve of the form-holder (20), if the smaller part locate at side of user's body. So pets feel safe in walking because the bag is not shook.

This form-holder (20) basically keep the frame of the main body (10) and perform the opening and closing operation which open the open-part (11) optionally as pushing out join-part (22) of the main body (10) and close the open-part (11) as reverting original state.

The form-holder (20) keep state to push out the join-part (22) of the main body (10), so pet's head in the admitted space (12) expose outside and he can see outside. Also it close the open-part (11) as reverting original state, so it protect pets safety if pets is sleeping or it is rainy or cold wave or abnormal weather.

This invention has the extended-part (23) of fixed width and does not make the form-holder (20) over the all part because the opening and closing operation of the form-holder (20) is smooth. Then the extended-part (23) is backstitch the shoulder strap (30), so pushing or reverting of the form-holder (20) is easy and after operation, state to the opening of closing is maintained without artificial way.

The shoulder strap (30) is linked as a join-ring (31), so user can control length to fit user's body.

According to this invention, a pet can be admit comfortably with stooping down in the admitted space (12) and see outside by exposing his head like FIG. 3.

If a pet sleep or is in abnormal weather in this state, user fold up a couple of the form-holder (20) and close the open-part (11).

If user wear the bag, the form-holder (20) adhere closely to his body and prevent shaking of the bag. So a pet is solved uneasiness and in a master's arms peacefully.

### INDUSTRIAL APPLICABILITY

This invention offer following effect. It has admitted-space to keep pets most easy pose, so it can admit pets comfortably.

It is set form-holder on the open-part and it can open or close the open-part optionally, so pet's head expose outside. Then Pets can see outside normally, and feel ease inside admitted-space in abnormal weather.

Also it can adhere closely to user's body and prevent shaking on walk.

1. A moving bag for pets, comprising:
a main body having a space to house a pet and a bottom for the pet to lie on, wherein the bottom is partitioned to a front portion for the pet's head and a rear portion for the pet's body, wherein the bottom is lowered from the front portion toward the rear portion;
elongate shaping holders in pair to control opening and closing of the space, wherein the holders are formed such that when the holders are opened a gap between the holders decrements from a body front corresponding to the front portion toward a body rear corresponding to the rear portion;
a length adjustable shoulder strap linking the body front and the body rear.

2. The moving bag of claim 1, wherein the shaping holders are outwardly flapped over to open the space and inwardly flapped back to close the space.

3. The moving bag of claim 2, wherein an extended part is formed near the body front to facilitate the opening and closing of the shaping holders, wherein the shoulder strap is sewn to the extended part, whereby when the pet is carried in the bag the rear portion stays closer to a user's waist side.
